(19) United States
(12) Patent Application Publication
(10) Pub. No.: US 2023/0270112 A1
(43) Pub. Date: Aug. 31, 2023

(54) A METHOD OF DISINFECTING A GASEOUS ENVIRONMENT, A LIQUID, OR A SOLID SURFACE

(71) Applicant: AQDOT LIMITED, Cambridge (GB)

(72) Inventors: Roger COULSTON, Cambridge (GB); Andrew HOWE, Cambridge (GB)

(73) Assignee: AQDOT LIMITED, Cambridge (GB)

(21) Appl. No.: 18/013,073

(22) PCT Filed: Jun. 24, 2021
(86) PCT No.: PCT/GB2021/051613

§ 371 Date: Dec. 27, 2022

(30) Foreign Application Priority Data
Jun. 24, 2020 (GB) 2009637.6
Jun. 26, 2020 (GB) 2009788.7
Mar. 3, 2021 (GB) 2103000.2
Jun. 24, 2021 (GB) 2109130.1

(51) Int. Cl. A01N 43/90; A01P 15/00; A01N 25/04

(52) U.S. Cl. CPC A01N 43/90; A01P 15/00; A01N 25/04

(57) ABSTRACT

A method of disinfecting or preventing infection of a gaseous environment by, a liquid of, or a solid surface of one of an enveloped virus, a non-enveloped virus, or a mixture thereof, the method including the step of treating the gaseous environment, liquid, or solid surface with a composition including an effective amount of one or more cucurbituril isomers, derivatives thereof, and variants thereof or, for preventing infection of a solid surface, including the step of producing the solid surface from a composition including an effective amount of one or more cucurbituril isomers, derivatives thereof, and variants thereof.

This invention relates to a method of disinfecting or preventing infection of a gaseous environment by, a liquid of, or a solid surface of one of an enveloped virus, a non-enveloped virus, or a mixture thereof.

There is a perennial need to control the spread of viruses by disinfecting or preventing infection of gaseous environments, liquids, or solid surfaces at ambient temperature, for example whilst room temperature is typically 18-25, or 18-23 degrees centigrade, it can range from 5-50, 10-45, 15-40 degrees centigrade. Ambient temperature benefiting from the body heat of a mammal, for example a human being, is nearer mammal body temperature and can be in the range, for example, of 20-37, 25-37, 30-37 degrees centigrade. Effective compositions tend to be cytotoxic and are thus not easy to handle (often requiring use of protective gear) or suitable for use on or in more delicate environments such as on human mucous membranes.

It has been observed that cucurbituril isomers are effective at preventing infection of cells by a variety of enveloped and non-enveloped viruses without accompanying cytotoxicity.

### SUMMARY OF THE INVENTION

The invention provides a method of disinfecting or preventing infection of a gaseous environment by, a liquid of, or a solid surface of one of an enveloped virus, a non-enveloped virus, or a mixture thereof, the method comprising the step of treating said gaseous environment, liquid, or solid surface with a composition comprising an effective amount of one or more cucurbituril isomers, derivatives thereof, and variants thereof or, for preventing infection of a solid surface, comprising the step of producing said solid surface from a composition comprising an effective amount of one or more cucurbituril isomers, derivatives thereof, and variants thereof.

The terms “disinfecting” and “preventing infection” in the context of the invention means that the virus is at least partially inactivated without necessarily leading to destruction of the virus or build-up of active virus. Thus at least 10, 20, 30, 40, 50, 60, 70, 80, 90% of the virus virions are inactivated on disinfection.

By the terms “gaseous environment, a liquid, or a solid surface” is meant gaseous environment, a liquid, or a solid surface at ambient temperature, for example at room temperature the temperature is typically 18-25, or 18-23 degrees centigrade, although it can range from 5-50, 10-45, 15-40 degrees centigrade. Ambient temperature benefiting from the body heat of a mammal, for example a human being, is nearer mammal body temperature and can be in the range, for example, of 20-37, 25-37, 30-37 degrees centigrade.

An enveloped virus is a virus with a viral envelope as an outermost layer which provides protection for the genetic material of the virus when traveling between host cells. Not all viruses have envelopes. The envelopes are typically derived from portions of the host cell membranes (phospholipids and proteins), but include some viral glycoproteins. Glycoproteins on the surface of the envelope serve to identify and bind to receptor sites on the host's membrane. The viral envelope then fuses with the host's membrane, allowing the capsid and viral genome to enter and infect the host.

In a non-enveloped virus the genetic material of the virus is protected by the protein capsid, and detector proteins serve to identify and bind to receptor sites on the host cell membrane. Non-enveloped viruses typically have higher resistance to disinfection than enveloped viruses because the envelopes are more susceptible to disruption.

Whilst not being bound by theory, it is thought that the cucurbituril isomers, derivatives thereof, or variants thereof complex with the surface of virus virions blocking their ability to bind to the specific receptors on the host cellular surface.

### BRIEF DESCRIPTION OF THE FIGURES

The invention is now described in more detail with reference to:

FIGS. 1a to 1g which show the % cell infection versus sample dilution for each of samples C1 to C4 and C6 to C8 which comprise different cucurbituril isomers at varying concentrations in different aqueous media;

FIGS. 2a to 2d which show the results of the % cell infection versus sample dilution for samples D1, D2 and D4 to D8 which comprise different cucurbituril isomers at varying concentrations in different aqueous media; and

FIGS. 3a to 3c which show the TCID⁵⁰ results of the effects of cucurbiturils on (a) herpes simplex virus serotype 2 (HSV-2) (n=3), (b) respiratory syncytial virus (RSV) (n=2), and (c) SARS-CoV-2 (n=1) (dotted lines indicate limits of detection; and error bars indicate standard deviation);

FIGS. 4a and 4b which show the results of a dose response assay against (a) herpes simplex virus serotype 2 (HSV-2) (n=2), and (b) respiratory syncytial virus (RSV) (n=1 for AqFresh® and n=2 for cucurbit[7]uril) (error bars indicate standard deviation);

FIG. 5 which shows virucidal assay data for herpes simplex virus serotype 2 (HSV-2) showing a 2-log reduction in viral titre with cucurbit[7]uril indicating cucurbit[7]uril acts virucidally (n=3; error bars indicate standard deviation);

FIG. 6 which shows the results of a DNA-exposure assay illustrating that cucurbit[7]uril and AqFresh® are associated with release of DNA from herpes simplex virus serotype 2 (HSV-2); and

FIG. 7 which shows the results of a time of addition study suggesting that cucurbit[7]uril only inhibits herpes simplex virus serotype 2 (HSV-2) titre when added simultaneously with the virus to cells, and not when added before or after viral exposure (n=2; dotted lines indicate limits of detection).

### DETAILED DESCRIPTION OF THE INVENTION

The invention provides a method of disinfecting or preventing infection of a gaseous environment by, a liquid of, or a solid surface of one of an enveloped virus, a non-enveloped virus, or a mixture thereof, the method comprising the step of treating said gaseous environment, liquid, or solid surface with a composition comprising an effective amount of one or more cucurbituril isomers, derivatives thereof, and variants thereof or, for preventing infection of a solid surface, comprising the step of producing said solid surface from a composition comprising an effective amount of one or more cucurbituril isomers, derivatives thereof, and variants thereof.

Cucurbit[8]uril (CB[8]; CAS 259886-51-6) is a barrel shaped container molecule which has eight repeat glycoluril units and an internal cavity size of 479 A³ (see structure below). CB[8] is readily synthesised using standard techniques and is available commercially (e.g. Sigma-Aldrich, MO USA).

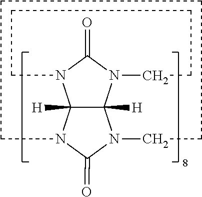

Other cucurbituril isomers are formed from different numbers of glycoluril numbers.

A variant of CB[8] may include a structure having one or more repeat units that are structurally analogous to glycoluril. The repeat unit may include an ethylurea unit. Where all the units are ethylurea units, the variant is a hemicucurbituril. The variant may be a hemicucurbit[12]uril as shown below:

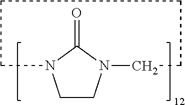

A derivative of a cucurbituril is a structure having one, two, three, four or more substituted glycoluril units. A substituted cucurbituril compound may be represented by the structure below:

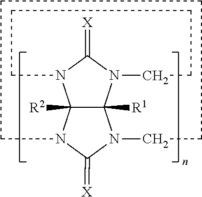

wherein:
n is an integer of at least 5;
and for each glycoluril unit each X is O, S or NR³, and
—R¹ and —R² are each independently selected from —H and the following optionally substituted groups: —R³, —OH, —OR³, —COOR³, —NH₂, —NHR³ and —N(R³)₂, a phosphorus oxoacid substituent, a sulphur oxoacid substituent, a carboxylic acid substituent where —R³ is independently selected from C₁₋₂₀ alkyl, C₆₋₂₀ carboaryl, and C₅₋₂₀ heteroaryl, or where —R¹ and/or —R² is —N(R³)₂, both —R³ together form a C₅₋₇ heterocyclic ring; or together —R¹ and —R² are C₄₋₆alkylene forming a C₆₋₈carbocyclic ring together with the uracil frame.

In one embodiment, one of the glycoluril units is a substituted glycoluril unit. Thus, —R¹ and —R² are each independently —H for n−1 of the glycoluril units.

In one embodiment, each X is O. In another embodiment, each X is S.

Examples of phosphorus oxoacids include phosphinic acid, phosphonic acid, hypophosphoric acid, orthophosphoric acid, oligophosphoric acids, polyphosphoric acids, peroxomonophosphoric acid, isohypophosphoric acid, and mixed oxidation state phosphorus oxoacids.

Examples of sulphur oxoacids include sulphuric acid, polysulfuric acids, peroxymonosulfuric acid, peroxydisulfuric acid, dithionic acid, thiosulfuric acid, disulfurous acid, sulfurous acid, dithionous acid, sulfoxylic acid, polythionic acid, thiosulfurous acid, and dihydroxydisulfane.

Examples of carboxylic acids include straight and branched chain saturated carboxylic acids such as formic acid, unsaturated monocarboxylic acids (such as acrylic acid), fatty acids, amino acids, keto acids, aromatic carboxylic acids, polycarboxylic acids such as dicarboxylic and tricarboxylic acids, alpha hydroxy acids, divinylether fatty acids.

In one embodiment, —R¹ and —R² are each independently —H.

In one embodiment, for each unit one of —R¹ and —R² is H and the other is independently selected from —H and the following optionally substituted groups: —R³, —OH, —OR³, —COOH, —COOR³, —NH₂, —NHR³ and —N(R³)₂. In one embodiment, for one unit one of —R¹ and —R² is —H and the other is independently selected from —H and the following optionally substituted groups: —R³, —OH, —OR³, —COOH, —COOR³, —NH₂, —NHR³ and —N(R³)₂. In this embodiment, the remaining glycoluril units are such that —R¹ and —R² are each independently H.

Preferably —R³ is C₁₋₂₀ alkyl, most preferably C₁₋₆alkyl. The C₁₋₂₀ alkyl group may be linear and/or saturated. Each group —R³ may be independently unsubstituted or substituted.

Preferred substituents are selected from: —R⁴, —OH, —OR⁴, —SH, —SR⁴, —COOH, —COOR⁴, —NH₂, —NHR⁴ and —N(R⁴)₂, wherein —R⁴ is selected from C₁₋₂₀ alkyl, C₆₋₂₀ carboaryl, and C₅₋₂₀ heteroaryl. The substituents may be independently selected from —COOH and —COOR⁴.

In some embodiments, —R⁴ is not the same as —R³. In some embodiments, —R⁴ is preferably unsubstituted.

Where —R¹ and/or —R² is —OR³, —NHR³ or —N(R³)₂, then —R³ is preferably C₁₋₆alkyl. In some embodiments, —R³ is substituted with a substituent —OR⁴, —NHR⁴ or —N(R⁴)₂, wherein each —R⁴ is C₁₋₆alkyl and is itself preferably substituted.

Preferably the enveloped virus is selected from the group consisting of family Herpesviridae, Poxviridae, Hepadnaviridae, Asfarviridae, Flaviviridae, Togaviridae, Coronaviridae, Orthomyxoviridae, Paramyxoviridae, Rhabdoviridae, Bunyavirales, Filoviridae, Pneumoviridae, and Retroviridae.

The enveloped virus may be selected from the group consisting of genus simplexvirus, varicellovirus, orthopoxvirus, parapoxvirus, yatapoxvirus, molluscipoxvirus, orthohepadnavirus, hepacivirus, flavivirus, betacoronavirus, alphacoronavirus, deltacoronavirus, gammacoronavirus, alphainfluenzavirus, betainfluenzavirus, gammainfluenzavirus, morbillivirus, rubelavirus, lyssavirus, ebolavirus, orthopneumovirus, cytomegalovirus, and lentivirus.

More specifically the enveloped virus may be selected from the group consisting of species herpes simplex virus 1, herpes simplex virus 2, varicella zoster virus, modified vaccinia virus Ankara (MVA), hepatitis B virus, hepatitis C virus, West Nile virus, dengue virus, tick-borne encephalitis virus, yellow fever virus, Zika virus, Middle East respiratory syndrome-related coronavirus, Severe acute respiratory syndrome-related coronavirus such as SARS-CoV, SARS-CoV-2 and feline coronavirus (Strain Munich), influenza A virus, influenza B virus, influenza C virus, measles virus, mumps virus, rabies virus, ebola virus, respiratory syncytial virus, cytomegalovirus, HIV-1 virus and HIV-2 virus.

Preferably the non-enveloped virus is selected from the group consisting of family Picornaviridae, Caliciviridae, Adenoviridae, Reoviridae, Astroviridae, Circoviridae, Parvoviridae, Papillomaviridae and Polyomaviridae.

The non-enveloped virus may be selected from the group consisting of genus enterovirus, rotavirus, norovirus, vesivirus, mastadenovirus, mamastrovirus, cyclovirus, protoparvovirus, alphapolyomavirus, betapolyomavirus, and gammapolyomavirus.

More specifically the non-enveloped virus may be selected from the group consisting of species enterovirus A, enterovirus B, enterovirus C, coxsackievirus B4, poliovirus type 1, murine norovirus, feline calicivirus, rhinovirus A, rhinovirus B, rhinovirus C, Norwalk virus, Adenovirus type 5, and any one of rotavirus A to J.

In one embodiment, the composition comprises a cucurbituril isomer selected from any one of cucurbit[6]uril, cucurbit[7]uril, cucurbit[8]uril, derivatives thereof, variants thereof, and mixtures thereof. Thus the composition may comprise cucurbit[8]uril, derivatives thereof, variants thereof, and mixtures thereof, optionally the composition additionally comprises cucurbit[6]uril, a derivative thereof, a variant thereof, or a mixture thereof, and cucurbit[7]uril, a derivative thereof, a variant thereof, or a mixture thereof. Cucurbit[6]uril and cucurbit[7]uril are formed from respectively 6 and 7 glycoluril units.

The composition optionally additionally comprises phenoxyethanol. Phenoxyethanol is known to be effective against gram-negative and gram-positive bacteria, and the yeast Candida albicans, but was not observed to be cytotoxic in the examples described below.

More generally, the composition may additionally comprises a virucide, optionally wherein the virucide is selected from the group consisting of phenoxyethanol, alcohols such as isopropyl alcohol, ethanol and n-propanol, chlorine based bleach, peroxide-based bleach, an aldehyde such as formaldehyde, glutaraldehyde or ortho-phthalaldehyde, a quaternary ammonium compound such as benalkonium chloride or didecyldimethyl ammonium chloride, a chlorhexidine such as chlorhexidine digluconate, and an iodophor.

In one embodiment of the invention, the composition excludes other cucurbituril isomers, derivatives thereof, or variants thereof except cucurbit[7]uril or a derivative thereof or a variant thereof or a mixture thereof.

In another embodiment of the invention, the composition excludes other cucurbituril isomers, derivatives thereof, or variants thereof except cucurbit[8]uril or a derivative thereof or a variant thereof or a mixture thereof, and wherein the weight ratio between phenoxyethanol and cucurbit[8]uril, a derivative thereof, a variant thereof, or a mixture thereof may be less than 9:1, preferably less than 5, most preferably less than 3.

When the composition comprises a mixture of cucurbit[6]uril or a derivative thereof or a variant thereof or a mixture thereof, and cucurbit[7]uril or a derivative thereof or a variant thereof or a mixture thereof, and cucurbit[8]uril or a derivative thereof or a variant thereof or a mixture thereof, the weight ratio between phenoxyethanol and cucurbit[8]uril, a derivative thereof, a variant thereof, or a mixture thereof may be more than 5:1, preferably greater than 7:1, most preferably greater than 9:1.

The effective amount of one or more cucurbituril isomers, derivatives thereof, and variants thereof may be in the range 0.000005-5, 0.00005-2, 0.0005-1, 0.005-1, 0.05-1% w/v.

In one embodiment of the invention, when the composition comprises a mixture of cucurbit[6]uril or a derivative thereof or a variant thereof or a mixture thereof, and cucurbit[7]uril or a derivative thereof or a variant thereof or a mixture thereof, and cucurbit[8]uril or a derivative thereof or a variant thereof or a mixture thereof, cucurbit[8]uril, a derivative thereof, a variant thereof, or a mixture thereof comprises 10-30, preferably 15-25% w/w total cucurbiturils, wherein the term “cucurbiturils” means cucurbituril isomers, derivatives thereof, and variants thereof.

Optionally, when the composition comprises a mixture of cucurbit[6]uril or a derivative thereof or a variant thereof or a mixture thereof, and cucurbit[7]uril or a derivative thereof or a variant thereof or a mixture thereof, and cucurbit[8]uril or a derivative thereof or a variant thereof or a mixture thereof, cucurbituril other than cucurbit[6]uril, cucurbit[7]uril, cucurbit[8]uril, derivatives thereof, variants thereof, or a mixture thereof comprises less than 5, less than 1, less than 0.5% w/w total cucurbiturils, optionally wherein cucurbituril other than cucurbit[6]uril, cucurbit[7]uril, cucurbit[8]uril, derivatives thereof, variants thereof, or a mixture thereof comprises at least 0.001 or at least 0.01% w/w total cucurbiturils, wherein cucurbituril other than cucurbit[6]uril, cucurbit[7]uril, cucurbit[8]uril, derivatives thereof, variants thereof, or a mixture thereof is preferably selected from the group consisting of cucurbit[5]uril, any one of cucurbit[9]uril to cucurbit[20]uril, derivatives thereof, variants thereof and a mixture thereof.

More generally, when cucurbit[5]uril, derivatives thereof, or variants thereof are present in the composition, their concentration may be from about 0.01 to about 99, from about 0.01 to about 75, from about 0.01 to about 50, from about 0.1 to about 30, from about 0.1 to about 20, from about 0.1 to about 10, from about 0.1 to about 5, from about 0.1 to about 2, from about 0.1 to about 1, from about 0.1 to about 0.5% w/w total cucurbiturils in the composition. In one embodiment the composition is substantially free of cucurbit[5]uril. By “substantially free” is meant less than 0.01 or less than 0.001% w/w total cucurbiturils.

More generally, when cucurbit[6]uril, derivatives thereof, or variants thereof are present in the composition, their concentration may be from about 0.1 to about 99, from about 1 to about 75, from about 5 to about 60, from about 20 to about 60, from about 35 to about 60, from about 45 to about 60% w/w total cucurbiturils in the composition.

More generally, when cucurbit[7]uril, derivatives thereof, or variants thereof are present in the composition, their concentration may be from about 0.1 to 99, from about 5 to about 75, from about 10 to about 60, from about 20 to about 45 w/w total cucurbiturils in the composition. In one embodiment, the concentration of cucurbit[7]uril is less than 45% w/w total cucurbiturils in the composition.

More generally, when cucurbit[8]uril, derivatives thereof, or variants thereof are present in the composition, their concentration may be from about 0.1 to about 99.999, about 0.1 to about 99.99 from about 0.1 to about 99, from about 1 to about 98, from about 1 to about 97, from about 1 to about 96, from about 1 to about 95, from about 1 to about 75, from about 1 to about 50, from about 5 to about 40, from about 10 to about 30, from about 15 to about 25% w/w total weight cucurbiturils in the composition.

In one embodiment, the composition comprises from about 45 to about 60% by weight cucurbit[6]uril, derivatives thereof, or variants thereof, 20 to about 45% by weight cucurbit[7]uril, derivatives thereof, or variants thereof, and from about 15 to about 25% by weight cucurbit[8]uril, derivatives thereof, or variants thereof, and less than 1% by weight of cucurbit[9]uril and higher cucurbiturils, derivatives thereof, or variants thereof, based on the total weight of total cucurbiturils in the composition.

A cucurbituril isomer, derivative thereof, or variant thereof, may be covalently linked to another cucurbituril isomer, derivative thereof, or variant thereof via a linker group that is a substituent at position R¹ or R² at one of the glycoluril units in the cucurbit[8]uril structure or represented in the structure shown above or other cucurbituril isomer. There are no particular limitations on the covalent link between the cucurbituril isomers, derivatives thereof, or variants thereof. The cucurbituril isomers, derivatives thereof, or variants thereof may be pendant to a polymer.

The composition may comprise a carrier and additional excipients which depends on whether the composition is for disinfecting or for preventing infection of a gaseous environment, or a liquid, or a solid surface, or is for preventing infection of a solid surface by producing said solid surface comprising the composition. Thus the composition may comprise thickener, pigments (such as titanium dioxide or iron oxides) and/or extender pigments (such as talc, mica or diatomaceous earth), ultra-violet light absorbers (such as benzophenone) or scatterers (such as micronized titanium dioxide), buffers, sequestrants, and anti-microbial agents. The carrier may be aqueous, non-aqueous, or an emulsion, but is preferably aqueous.

The composition is optionally in the form of a solution or liquid suspension, optionally suitable for dispensing as an aerosol or spray, or in the form of a liquid coating and the step of treating the solid surface is coating the solid surface with the liquid composition.

The solid surface may be part of an air filter cartridge, part of an item of medical personal protective equipment such as a mask or a pair of gloves, a wipe, or a human mucous membrane such as found in nasal passages or eyes. The composition may be applied to the surface of the solid surface or incorporated into the solid surface. Knowledge of how to Incorporate the composition into the solid surface of, for example, a part of an air filter cartridge, mask, gloves or a wipe, is within the ambit of the skilled person. The non-toxic or cytotoxic nature of the composition is particularly useful for application to human mucous membrane as use of the composition is less likely to result in unpleasant or dangerous side effects.

### Example 1: Inactivation of a SARS-COV-2 Pseudotyped Virus

The samples shown in Table 1, in duplicate, were diluted 1:5 v/v in Dulbecco's Modified Eagle's Medium (DMEM) and then with 100 microlitres of SARS-COV-2 pseudotyped virus (10¹²⁻¹³ virions comprising a SARS-COV-2 envelope and an HIV-derived RNA interior further genetically modified to carry a luciferase reporter gene in Dulbecco's Modified Eagle's Medium) for a final dilution of 1:10 v/v. The SARS-COV-2 pseudotyped virus was prepared using techniques known to the skilled person in the art, for example, as described in Crawford et al. (“Protocol and Reagents for Pseudotyping Lentiviral Particles with SARS-CoV-2 Spike Protein for Neutralization Assays”, Viruses, 12, 513 (2020)), Hoffmann et al. (“SARS-CoV-2 Cell Entry Depends on ACE2 and TMPRSS2 and Is Blocked by a Clinically Proven Protease Inhibitor”, Cell, 181, 271-280 (2020)) and Giroglou et al. (“Retroviral Vectors Pseudotyped with Severe Acute Respiratory Syndrome Coronavirus S Protein”, Journal of Virology, 9007-9015 (September 2004)). Further dilutions were carried out whilst maintaining the concentration of virions constant.

TABLE 1
Description of test samples of cucurbituril in aqueous media.

| Sample | | |
|---|---|---|
| number | Cucurbituril | Aqueous media |
| C1 | 0.5% w/v | DMEM² |
| | cucurbit[n]uril¹ | |
| C2 | 0.5% w/v | DMEM |
| | cucurbit[7]uril³ | |
| C3 | 0.5% w/v | DMEM |
| | cucurbit[8]uril | |
| C4 | 0.5% w/v | 0.95% w/v phenoxyethanol and 0.13% |
| | cucurbit[n]uril | w/v xanthan gum |
| C6 | 0.5% w/v | 3% w/v lactic acid and 1% w/v sodium |
| | cucurbit[n]uril | laureth sulphate |
| C7 | 1% w/v | 0.95% w/v phenoxyethanol and 0.26% |
| | cucurbit[n]uril | w/v xanthan gum |
| C8 | 0.5% w/v | 0.5% w/v copper sulphate |
| | cucurbit[n]uril | |

¹Cucurbit[n]uril is a mixture of cucurbit[6]uril, cucurbit[7]uril and cucurbit[8]uril with about 20% w/w cucurbit[8]uril and less than 1% w/w other cucurbituril isomers prepared in accordance with the process described on pages 1 to 14 and in the Examples of WO 2018/115822 (Aqdot Limited), and is available from AQDOT LIMITED, Cambridge, United Kingdom.
²Dulbecco's Modified Eagle's Medium.
³Available from Sigma-Aldrich Inc.

The various diluted samples were incubated at 37 degrees centigrade for 2 hours to allow the samples to inactivate the pseudotyped virus. The diluted samples were then added to 293T-ACE2-TMPRSS2 cells (human embryonic kidney cells and prepared by the Virology Department at University of Cambridge) and the cells incubated at 37 degrees centigrade for 48 hours to allow the virus to reproduce and thus the amount of luciferase to increase. Angiotensin-converting enzyme 2 (ACE2) is an enzyme attached to the cell membranes of cells which serves as the entry point into cells for some coronaviruses, including SARS-COV-2. It is reported by Hoffmann et al. that SARS-COV-2 uses the SARS-COV receptor ACE2 for entry and the serine protease TMPRSS2 (transmembrane serine protease 2) for viral spike protein priming. Cell survival was recorded as assessed by visual observation using optical microscopy and diluted samples where cell survival was no higher than 50% were discarded. The cells for the remaining diluted samples were lysed and the concentration of luciferase was measured for each diluted sample using a luminometer to indicate the level of virus reproduction and hence virus infection of the cells.

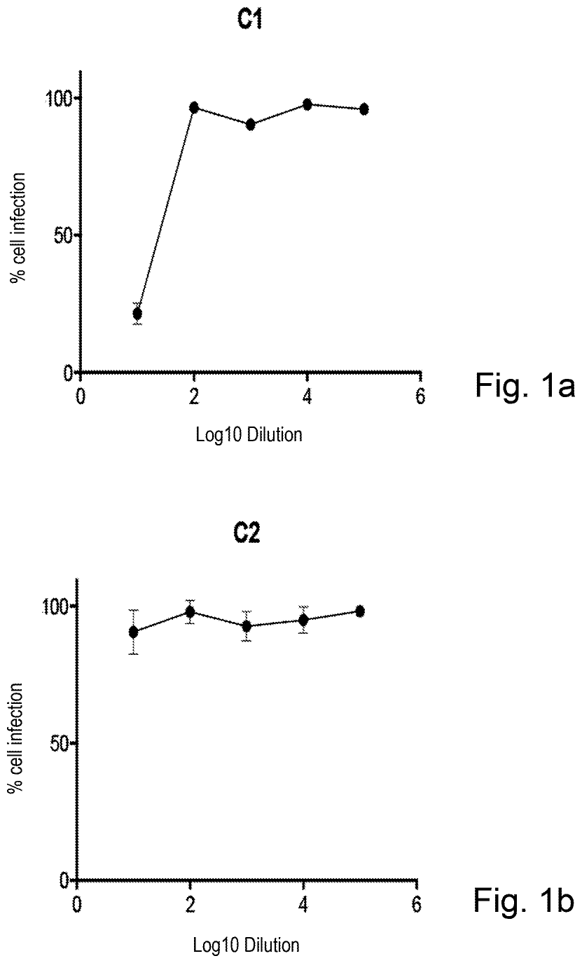

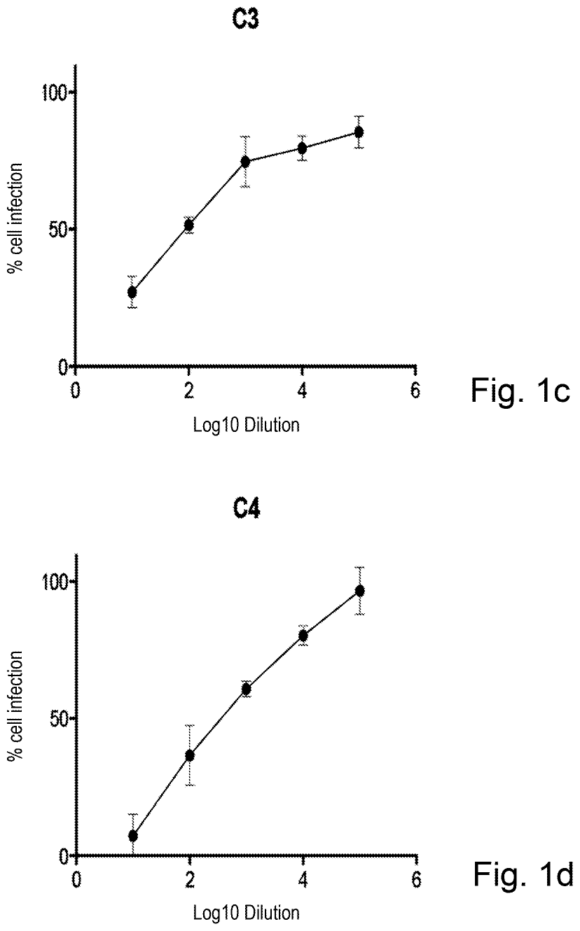

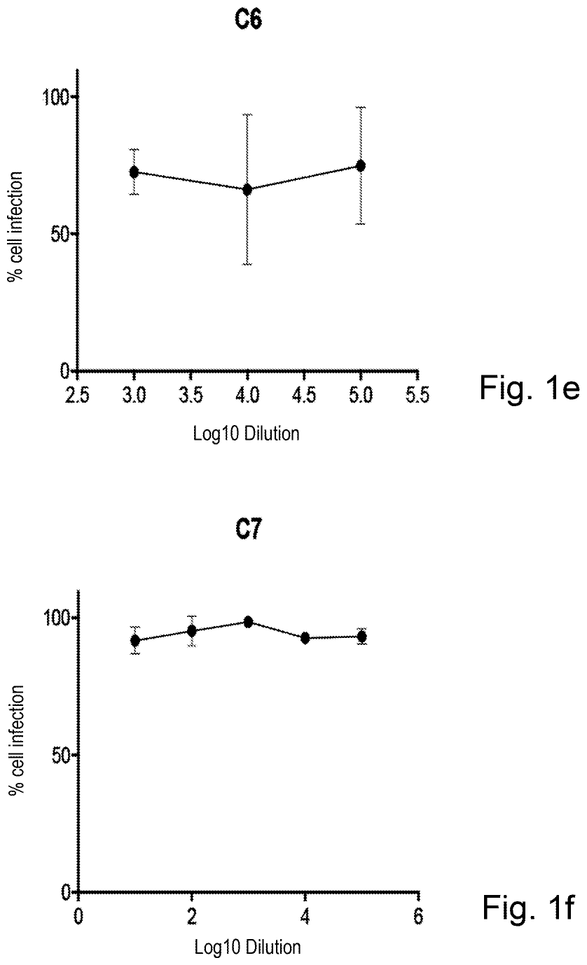

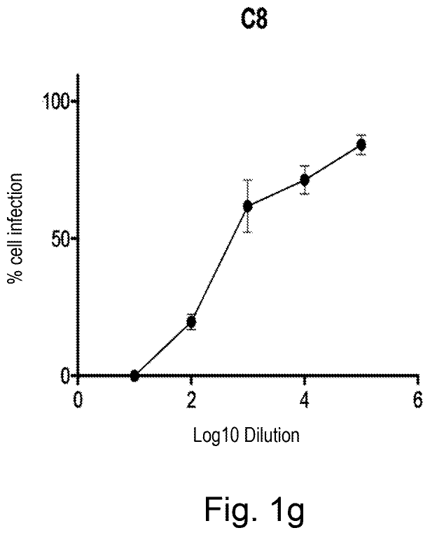

The results of the luciferase measurements are reproduced in FIGS. 1a to 1g which show the % cell infection versus sample dilution for each of samples C1 to C8. The 1:10 and 1:100 dilutions for sample C6 showed cell survival no higher than 50% and the luciferase concentration was therefore not measured for these dilutions. Both samples comprise anti-bacterial compounds. C8, which also comprises an antibacterial compound and was effective at preventing cell infection, also showed signs of cell death. Samples C2, C6 and C7 were shown to be ineffective at preventing cell infection. In contrast, samples C1, C3 and C4 were effective at preventing cell infection. Samples C1 and C3 furthermore do not comprise an anti-bacterial compound.

The foregoing description of the results is reflected in the IC₅₀, i.e., the dilution factor of the samples required to achieve a reduction of at least 50% in cell infection, which are summarised in Table 2.

TABLE 2
The dilution factor for each sample required to achieve
a reduction of at least 50% in cell infection (IC₅₀).

| Sample | | | |
|---|---|---|---|
| number | Cucurbituril | Aqueous media | IC₅₀ |
| C1 | 0.5% w/v | DMEM | 19 |
| | cucurbit[n]uril | | |
| C2 | 0.5% w/v | DMEM | — |
| | cucurbit[7]uril | | |
| C3 | 0.5% w/v | DMEM | 102 |
| | cucurbit[8]uril | | |
| C4 | 0.5% w/v | 0.95% w/v phenoxyethanol | 422 |
| | cucurbit[n]uril | and 0.13% w/v xanthan gum | |
| C6 | 0.5% w/v | 3% w/v lactic acid^{a} and 1% | — |
| | cucurbit[n]uril | w/v sodium laureth sulphate | |
| C7 | 1% w/v | 0.95% w/v phenoxyethanol | — |
| | cucurbit[n]uril | and 0.26% w/v xanthan gum | |
| C8 | 0.5% w/v | 0.5% w/v copper sulphate^{b} | 988 |
| | cucurbit[n]uril | | |

^{a}known anti-bacterial
^{b}known fungicide, herbicide and algicide

### Example 2: Inactivation of a SARS-COV-2 Pseudotyped Virus

A second series of samples comprising cucurbituril isomers in aqueous media were tested in the same manner as described for Example 1 except on this occasion, the dilutions of sample and virus were allowed to incubate for just 1 hour at 37 degrees centigrade.

A description of each sample and the IC₅₀ for each is provided in Table 3.

TABLE 3
Description of test samples of cucurbituril in aqueous media
and corresponding dilution factor for each sample required to
achieve a reduction of at least 50% in cell infection (IC₅₀).

| Sample | | | |
|---|---|---|---|
| number | Cucurbituril | Aqueous media | IC₅₀ |
| D1 | 0.5% w/v | 0.95% w/v phenoxyethanol | 970 |
| | cucurbit[n]uril | and 0.13% w/v xanthan gum | |
| D2 | 0.5% w/v | DMEM | 113 |
| | cucurbit[8]uril | | |
| D4 | 0.5% w/v | 0.95% w/v phenoxyethanol | 106 |
| | cucurbit[n]uril | and 0.13% w/v xanthan gum | |
| D5 | 0.1% w/v | 0.95% w/v phenoxyethanol | 1.4 |
| | cucurbit[8]uril | and 0.13% w/v xanthan gum | |
| D6 | 0.5% w/v | 0.95% w/v phenoxyethanol | 18 |
| | cucurbit[8]uril | and 0.13% w/v xanthan gum | |
| D7 | 0.5% w/v | 0.1% w/v phenoxyethanol in DMEM | 27 |
| | cucurbit[8]uril | | |
| D8 | 0.5% w/v | 0.1% w/v sodium laureth | 16 |
| | cucurbit[8]uril | sulphate in DMEM | |

Notable cell death was not observed with any of the sample at any of the tested dilutions. Samples D6, D7 and D8 all comprise 0.5% w/v cucurbit[8]uril and have similar IC₅₀ values regardless of the presence of the anti-bacterial agent phenoxyethanol, whereas sample D5 which comprises only 0.1% w/v cucurbit[8]uril has a significantly lower IC₅₀ value. Sample D2, which also comprises 0.5% w/v cucurbit[8]uril has a much higher IC₅₀ value suggesting that the presence of phenoxyethanol or sodium laureth sulphate at the tested levels may reduce the effectiveness of cucurbit[8]uril at reducing cell infection by the virus. The difference in IC₅₀ value for samples D1 and D4 suggests that there is a difference in ostensibly identical test products (which were prepared separately), however it is clear from those values that, regardless, cucurbit[n]uril appears to be less effective than cucurbit[8]uril in the presence of phenoxyethanol and xanthan gum at the tested levels of cucurbituril, phenoxyethanol and xanthan gum. Sample D2 comprising 0.5% w/v cucurbit[8]uril in DMEM replicates accurately the result for the duplicate sample C3 in Example 1.

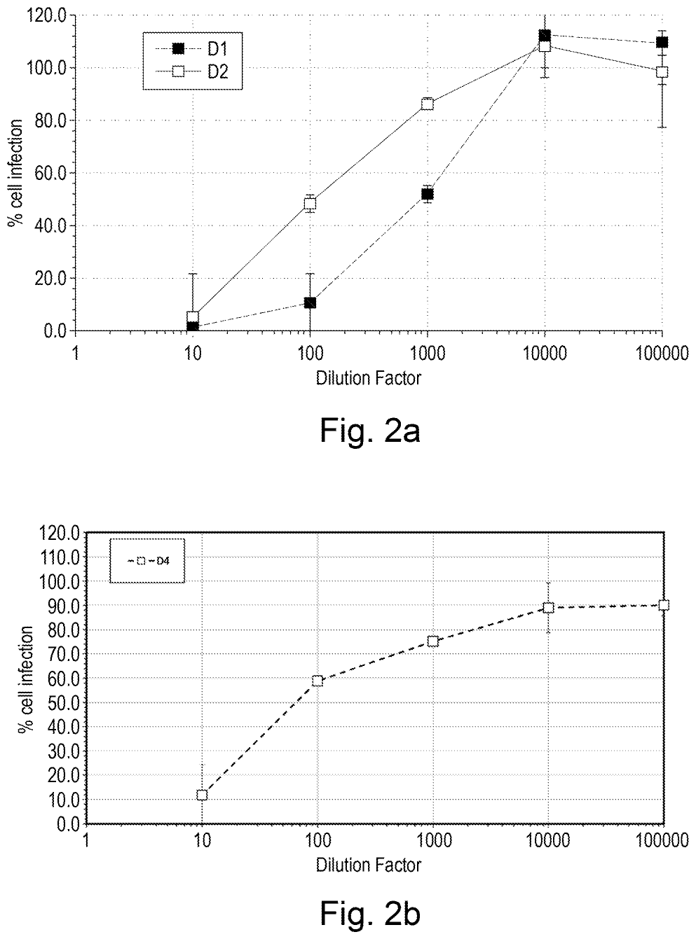

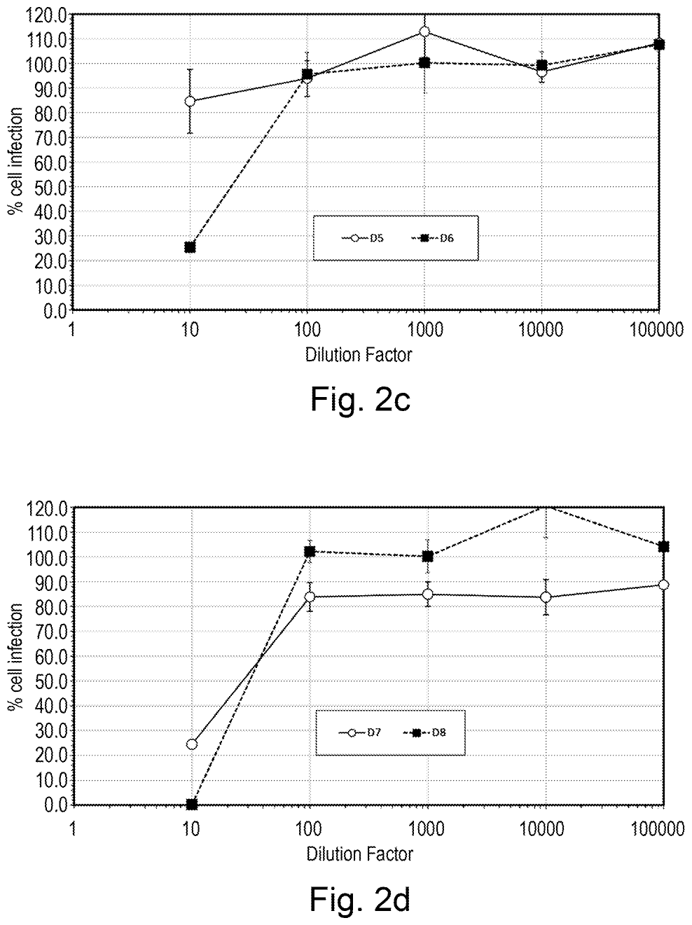

FIGS. 2a to 2d illustrate the results of the % cell infection versus sample dilution for samples D1, D2 and D4 to D8.

### Example 3: Inactivation of Murine Norovirus (Strain S99 Berlin)

Virucidal activity of an aqueous suspension of mixed amorphous cucurbituril particles (a dry mixture of cucurbit[6]uril, cucurbit[7]uril and cucurbit[8]uril sold as AqFresh® by Aqdot Limited, England) against murine norovirus (strain S99 Berlin), a non-enveloped RNA virus, was determined under British Standard method BS EN 14476: 2013+A2: 2019 ‘Chemical disinfectants and antiseptics—Quantitative suspension test for the evaluation of virucidal activity in the medical area’. The standard method describes a test method and the minimum requirements for virucidal activity of a chemical disinfectant and antiseptic products that form a homogenous physically stable preparation when diluted with deionised water. Products can only be tested at a maximum concentration of 80% v/v as some dilution is always produced by adding the test organisms and interfering substances.

In brief, a sample of the test product (neat or diluted in deionised water) was added to a test suspension of virus in a solution of interfering substance. The mixture was maintained at 20+/−1 degrees centigrade for about 5 minutes or about 60 minutes. At the end of this contact time, an aliquot was taken and the virucidal action in this portion was immediately suppressed by dilution of the sample in ice-cold cell maintenance medium. The dilutions were transferred into cell culture units using cell suspension. Infectivity tests were completed using the quantal test. After incubation, the titres of infectivity were calculated according to Spearman and Käber. Reduction of virus infectivity was calculated from differences of log virus titres before (virus control) and after treatment with the product.

The aqueous suspension has a pH 3.7-4.9 and has the composition (% w/w): 98.42 water, 0.13 xanthum gum, 0.95 phenoxyethanol, and 0.50 AqFresh®.

The virucidal performance of the aqueous suspension was tested with the interfering substances of 0.3 g/I bovine serum albumin and a mixture of 3 g/I bovine serum albumin and 3 ml/I sheep erythrocytes, and at concentrations of 80, 50 and 0.10% v/v.

The results as Log TCID₅₀ are presented in Tables 4a and 4b below with the interfering substances of 3 g/I bovine serum albumin and a mixture of 3 g/I bovine serum albumin and 3 ml/I sheep erythrocytes respectively. Log TCID₅₀ is the negative logarithm of the 50% infecting dose of a virus suspension or that dilution of the virus suspension that induces a CPE in 50% of cell culture units, wherein CPE (viral cytopathic effect) means a morphological alteration of cells and/or their destruction as a consequence of viral multiplication as recited in Section 3 and Annex C.1 of BS EN 14476: 2013+A2: 2019.

TABLE 4a
Log TCID₅₀ for murine norovirus (strain S99 Berlin) at aqueous
suspension concentrations of 80, 50 and 0.10% v/v with interfering
substance of 0.3 g/l bovine serum albumin.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 6.67 | 0 | 100 |
| 0.10 | 5 | 6.58 | 0.08 | 83 |
| 50 | 5 | 5.83 | 0.83 | 15 |
| 80 | 5 | 5.75 | 0.92 | 12 |
| 0 | 60 | 6.50 | 0 | 100 |
| 0.10 | 60 | 6.33 | 0.17 | 68 |
| 50 | 60 | 5.50 | 1.00 | 10 |
| 80 | 60 | 5.50 | 1.00 | 10 |

TABLE 4b
Log TCID₅₀ for murine norovirus (strain S99 Berlin)
at aqueous suspension concentrations of 80, 50 and
0.10% v/v with interfering substances of 3 g/l bovine
serum albumin and 3 ml/l sheep erythrocytes.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 7.00 | 0 | 100 |
| 0.10 | 5 | 6.96 | 0.04 | 91 |
| 50 | 5 | 6.38 | 0.63 | 23 |
| 80 | 5 | 6.21 | 0.79 | 16 |
| 0 | 60 | 6.71 | 0 | 100 |
| 0.10 | 60 | 6.83 | −0.12 | 132 |
| 50 | 60 | 6.04 | 0.67 | 21 |
| 80 | 60 | 5.92 | 0.79 | 16 |

### Example 4: Inactivation of Modified Vaccinia Virus Ankara (MVA), ATCC VR-1508

Virucidal activity of the aqueous suspension of mixed amorphous cucurbituril particles (AqFresh® from Aqdot Limited, England) of Example 3 against modified vaccinia virus Ankara (MVA), ATCC VR-1508, an enveloped DNA virus, was determined in the same manner as described for Example 3.

The results as Log TCID₅₀ are presented in Tables 5a and 5b below with the interfering substances of 0.3 g/Il bovine serum albumin and a mixture of 3 g/I bovine serum albumin and 3 ml/I sheep erythrocytes respectively.

TABLE 5a
Log TCID₅₀ for modified vaccinia virus Ankara (MVA) (ATCC VR-1508)
at aqueous suspension concentrations of 80, 50 and 0.10% v/v
with interfering substance of 0.3 g/l bovine serum albumin.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 7.08 | 0 | 100 |
| 0.10 | 5 | 7.04 | 0.04 | 91 |
| 50 | 5 | 6.50 | 0.58 | 26 |
| 80 | 5 | 6.00 | 1.08 | 8 |
| 0 | 60 | 6.88 | 0 | 100 |
| 0.10 | 60 | 6.88 | 0 | 100 |
| 50 | 60 | 6.17 | 0.71 | 19 |
| 80 | 60 | 5.63 | 1.25 | 6 |

TABLE 5b
Log TCID₅₀ for modified vaccinia virus Ankara (MVA) (ATCC
VR-1508) at aqueous suspension concentrations of 80,
50 and 0.10% v/v with interfering substances of 3 g/l
bovine serum albumin and 3 ml/l sheep erythrocytes.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 7.17 | 0 | 100 |
| 0.10 | 5 | 7.08 | 0.08 | 83 |
| 50 | 5 | 7.00 | 0.17 | 68 |
| 80 | 5 | 6.46 | 0.71 | 19 |
| 0 | 60 | 7.04 | 0 | 100 |
| 0.10 | 60 | 7.13 | −0.08 | 120 |
| 50 | 60 | 6.79 | 0.25 | 56 |
| 80 | 60 | 6.29 | 0.75 | 18 |

### Example 5: Inactivation of Feline Coronavirus (Strain Munich)

Virucidal activity of the aqueous suspension of mixed amorphous cucurbituril particles (AqFresh® from Aqdot Limited, England) of Example 3 against feline coronavirus (Strain Munich), an enveloped RNA virus, was determined in the same manner as described for Example 3.

The results as Log TCID₅₀ are presented in Tables 6a and 6b below with the interfering substances of 0.3 g/l bovine serum albumin and a mixture of 3 g/l bovine serum albumin and 3 ml/l sheep erythrocytes respectively.

TABLE 6a
Log TCID₅₀ for feline coronavirus (Strain Munich) at aqueous
suspension concentrations of 80, 50 and 0.10% v/v with interfering
substance of 0.3 g/l bovine serum albumin.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 6.58 | 0 | 100 |
| 0.10 | 5 | 6.46 | 0.13 | 74 |
| 50 | 5 | 6.17 | 0.42 | 38 |
| 80 | 5 | 5.38 | 1.21 | 6 |
| 0 | 60 | 6.42 | 0 | 100 |
| 0.10 | 60 | 6.29 | 0.13 | 74 |
| 50 | 60 | 5.88 | 0.54 | 29 |
| 80 | 60 | 5.00 | 1.42 | 4 |

TABLE 6b
Log TCID₅₀ for feline coronavirus (Strain Munich)
at aqueous suspension concentrations of 80, 50 and
0.10% v/v with interfering substances of 3 g/l bovine
serum albumin and 3 ml/l sheep erythrocytes.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 6.79 | 0 | 100 |
| 0.10 | 5 | 6.79 | 0 | 100 |
| 50 | 5 | 6.38 | 0.42 | 38 |
| 80 | 5 | 6.00 | 0.79 | 16 |
| 0 | 60 | 6.71 | 0 | 100 |
| 0.10 | 60 | 6.75 | −0.04 | 110 |
| 50 | 60 | 6.25 | 0.46 | 35 |
| 80 | 60 | 5.92 | 0.79 | 16 |

### Example 6: Inactivation of Poliovirus Type 1 (LSc 2Ab)

Virucidal activity of the aqueous suspension of mixed amorphous cucurbituril particles (AqFresh® from Aqdot Limited, England) of Example 3 against poliovirus type 1 (LSc 2ab), a non-enveloped RNA virus, was determined in the same manner as described for Example 3.

The results as Log TCID₅₀ are presented in Tables 7a and 7b below with the interfering substances of 0.3 g/l bovine serum albumin and a mixture of 3 g/l bovine serum albumin and 3 ml/I sheep erythrocytes respectively.

TABLE 7a
Log TCID₅₀ for poliovirus type 1 (LSc 2ab) at aqueous
suspension concentrations of 80, 50 and 0.10% v/v with
interfering substance of 0.3 g/l bovine serum albumin.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 6.75 | 0 | 100 |
| 0.10 | 5 | 6.88 | −0.13 | 135 |
| 50 | 5 | 6.75 | 0.00 | 100 |
| 80 | 5 | 6.58 | 0.17 | 68 |
| 0 | 60 | 6.63 | 0 | 100 |
| 0.10 | 60 | 6.58 | 0.04 | 91 |
| 50 | 60 | 6.54 | 0.08 | 83 |
| 80 | 60 | 6.54 | 0.08 | 83 |

TABLE 7b
Log TCID₅₀ for poliovirus type 1 (LSc 2ab) at aqueous suspension
concentrations of 80, 50 and 0.10% v/v with interfering substances
of 3 g/l bovine serum albumin and 3 ml/l sheep erythrocytes.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 7.08 | 0 | 100 |
| 0.10 | 5 | 7.08 | 0 | 100 |
| 50 | 5 | 7.08 | 0 | 100 |
| 80 | 5 | 7.00 | 0.08 | 83 |
| 0 | 60 | 7.04 | 0 | 100 |
| 0.10 | 60 | 7.00 | 0.04 | 91 |
| 50 | 60 | 7.04 | 0 | 100 |
| 80 | 60 | 6.92 | 0.13 | 74 |

### Example 7: Inactivation of Adenovirus Type 5 (Strain Adenoid 75 (ATCC VR-5))

Virucidal activity of the aqueous suspension of mixed amorphous cucurbituril particles (AqFresh® from Aqdot Limited, England) of Example 3 against adenovirus type 5 (strain Adenoid 75 (ATCC VR-5)), a non-enveloped DNA virus, was determined in the same manner as described for Example 3.

The results as Log TCID₅₀ are presented in Tables 8a and 8b below with the interfering substances of 0.3 g/l bovine serum albumin and a mixture of 3 g/l bovine serum albumin and 3 ml/l sheep erythrocytes respectively.

TABLE 8a
Log TCID₅₀ for adenovirus type 5 (strain Adenoid 75 (ATCC VR-
5)) at aqueous suspension concentrations of 80, 50 and 0.10%
v/v with interfering substance of 0.3 g/l bovine serum albumin.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 7.21 | 0 | 100 |
| 0.10 | 5 | 7.13 | 0.08 | 83 |
| 50 | 5 | 6.92 | 0.29 | 51 |
| 80 | 5 | 6.88 | 0.33 | 47 |
| 0 | 60 | 7.00 | 0 | 100 |
| 0.10 | 60 | 7.00 | 0 | 100 |
| 50 | 60 | 6.88 | 0.13 | 74 |
| 80 | 60 | 6.67 | 0.33 | 47 |

TABLE 8b
Log TCID₅₀ for adenovirus type 5 (strain Adenoid 75 (ATCC
VR-5)) at aqueous suspension concentrations of 80, 50
and 0.10% v/v with interfering substances of 3 g/l bovine
serum albumin and 3 ml/l sheep erythrocytes.

| | | | | Relative |
|---|---|---|---|---|
| Aqueous suspension | Virus contact | Log | Log | activity |
| concentration (% v/v) | time (minutes) | TCID₅₀ | reduction | (%) |
| 0 | 5 | 7.38 | 0 | 100 |
| 0.10 | 5 | 7.29 | 0.08 | 83 |
| 50 | 5 | 7.21 | 0.17 | 68 |
| 80 | 5 | 7.13 | 0.25 | 56 |
| 0 | 60 | 7.13 | 0 | 100 |
| 0.10 | 60 | 7.17 | −0.04 | 110 |
| 50 | 60 | 7.00 | 0.13 | 74 |
| 80 | 60 | 6.75 | 0.38 | 42 |

### Example 8: ISO 18184:2019 Textiles—Determination of Antiviral Activity of Textile Products (Treated with Aqueous Solution of AqFresh®)

20×20 mm cotton swatches (about 0.40 g) were treated with 1.6 ml of an aqueous solution of 5 mg AqFresh® per ml and allowed to soak for 2 minutes and then 200 microlitres of virus at a concentration of about 107 TCID₅₀ (giving a final concentration of 105) added at 25+/−1 degrees centigrade to the pre-treated cotton swatch and contact maintained for 2 hours+/−10 seconds.

Alternatively, 20×20 mm cotton swatches (about 0.40 g) were treated with 200 microlitres of virus at a concentration of about 107 TCID₅₀ (giving a final concentration of 105) at 25+/−1 degrees centigrade and then 1.6 ml of an aqueous solution of 5 mg AqFresh® per ml allowed to soak into the pre-treated cotton swatch for 2 minutes and contact maintained for 2 hours+/−10 seconds.

Following the contact time, the cotton swatch was recovered in 20 ml of cell culture media and enumerated onto an appropriate cell line. The TCID₅₀ was calculated following the appropriate incubation time and the antiviral activity calculated by comparison of the AqFresh® to the immediate recover from a control swatch.

Viral strains tested were feline corona virus (Strain Munich) and murine norovirus (strain S99 Berlin).

The results are set forth in Table 9a and Table 9b for murine norovirus (strain S99 Berlin) and feline corona virus (Strain Munich) respectively.

TABLE 9a
Determination of antiviral (murine norovirus (strain
S99 Berlin)) activity of textile product pre- or post-
treated with aqueous solution of AqFresh^{RTM} according
to ISO 18184: 2019 (^{a}without pre- or post-treatment
with aqueous solution of AqFresh^{RTM}; ‘post’ and
‘pre’ mean post-treatment and pre-treatment with
aqueous solution of AqFresh^{RTM} respectively).

| | Contact | | Average | Reduction | Reduction |
|---|---|---|---|---|---|
| | time | TCID₅₀ | TCID₅₀ | TCID₅₀ | TCID₅₀ |
| Swatch | (hours) | (Log) | (Log) | (Log) | (%) |
| Control 1^{a} | 0 | 6.00 | | | |
| Control 2 | 0 | 6.08 | | | |
| Control 3 | 0 | 6.00 | 6.03 | | |
| Control 1 | 2 | 5.58 | | | |
| Control 2 | 2 | 5.71 | | | |
| Control 3 | 2 | 5.67 | 5.65 | 0.37 | 57.72 |
| Test 1 (post) | 2 | 4.00 | | | |
| Test 2 (post) | 2 | 4.00 | | | |
| Test 3 (post) | 2 | 4.08 | 4.03 | 2.00 | 99.00 |
| Test 1 (pre) | 2 | 4.79 | | | |
| Test 2 (pre) | 2 | 5.29 | | | |
| Test 3 (pre) | 2 | 5.00 | 5.03 | 1.00 | 90.00 |

TABLE 9b
Determination of antiviral (feline corona virus (Strain
Munich)) activity of textile product post-treated with
aqueous solution of AqFresh^{RTM} according to ISO 18184:
2019 (^{a}without pre- or post-treatment with aqueous
solution of AqFresh^{RTM}).

| | Contact | | Average | Reduction | Reduction |
|---|---|---|---|---|---|
| | time | TCID₅₀ | TCID₅₀ | TCID₅₀ | TCID₅₀ |
| Swatch | (hours) | (Log) | (Log) | (Log) | (%) |
| Control 1^{a} | 0 | 5.96 | | | |
| Control 2 | 0 | 6.00 | | | |
| Control 3 | 0 | 5.92 | 5.96 | | |
| Control 1 | 2 | 6.00 | | | |
| Control 2 | 2 | 5.83 | | | |
| Control 3 | 2 | 5.79 | 5.87 | 0.08 | 17.57 |
| Test 1 | 2 | 4.00 | | | |
| Test 2 | 2 | 4.13 | | | |
| Test 3 | 2 | 4.13 | 4.08 | 1.88 | 98.67 |

### Example 9: Study of the Antiviral Properties of AqFresh®, Cucurbit[6]Uril, Cucurbit[7]Uril, and Cucurbit[8]Uril

Materials and Methods

Cucurbituril in dry powdered form were mixed with sterile deionized water (dH₂O) to form an initial 5% stock concentration (0.05 g of powder/mL dH₂O, a 50 mg/mL solution). These were then diluted appropriately in sterile dH₂O to form additional 2%, 1%, 0.5% and 0.05% stocks.

Viruses

Herpes simplex virus, serotype two (HSV-2) (additional stocks were grown on Vero cells in-lab and stored at −80° C.), respiratory syncytial virus (RSV) (additional stocks were grown on Vero cells in-lab and stored at −80° C.), murine norovirus (strain S99 Berlin), coronavirus (strains 229E and OC43) (additional stocks were grown on A549 cells in-lab and stored at −80° C.) and SARS-CoV-2.

Cell Culture

All tissue culture media was supplemented with 1% penicillin/streptomycin (P/S) (Merck Life Science UK Ltd, Dorset, United Kingdom) and 10% heat inactivated foetal calf serum (FCS) (Merck Life Science UK) unless stated otherwise.

Vero cells were maintained in Dulbecco's Modified Eagle Medium (DMEM) modified with high glucose, L-glutamine, phenol red and sodium pyruvate. Cells were cultivated at 37° C., 5% CO₂ in 75 cm² flasks and passaged in a 1:6 ratio when confluent.

RAW 264.7 cells (Merck Life Science) were maintained in DMEM modified with phenol red and L-glutamine. Cells were cultivated at 37° C., 5% CO₂ in 75 cm² flasks and passaged via cell scraping when confluent.

A549 cells were maintained in F-12K medium (Thermo Fisher Scientific). Cells were cultivated at 37° C., 5% CO₂ in 75 cm² flasks and passaged in a 1:6 ratio when confluent.

MK-1 Lu cells (mink lung epithelial cells) were maintained in DMEM modified with high glucose, sodium pyruvate, phenol red and L-glutamine. Cells were cultivated at 37° C., 5% CO₂ in 75 cm² flasks and passaged in a 1:6 ratio when confluent.

Titration by TCID₅₀ Assay

Samples were titrated in 96-well flat bottom plates in quadruplicate. The first four wells of the first column were filled with 180 μL of appropriate media (see Cell Culture) and all other wells were filled with 100 μL of media. The initial wells then had 20 μL of sample added, before the contents were mixed via pipetting. 100 μL of mixed sample was then transferred to the next four wells and mixed again. This serial dilution was repeated across the plate, with the exception of wells A12-D12, which were left unexposed to sample as a negative control. Plates were then incubated for an appropriate length of time depending on the virus being investigated. Virus titre was determined by cytopathic effects observed in wells via light microscopy examination. Titre was calculated using the Spearman-Karber method.

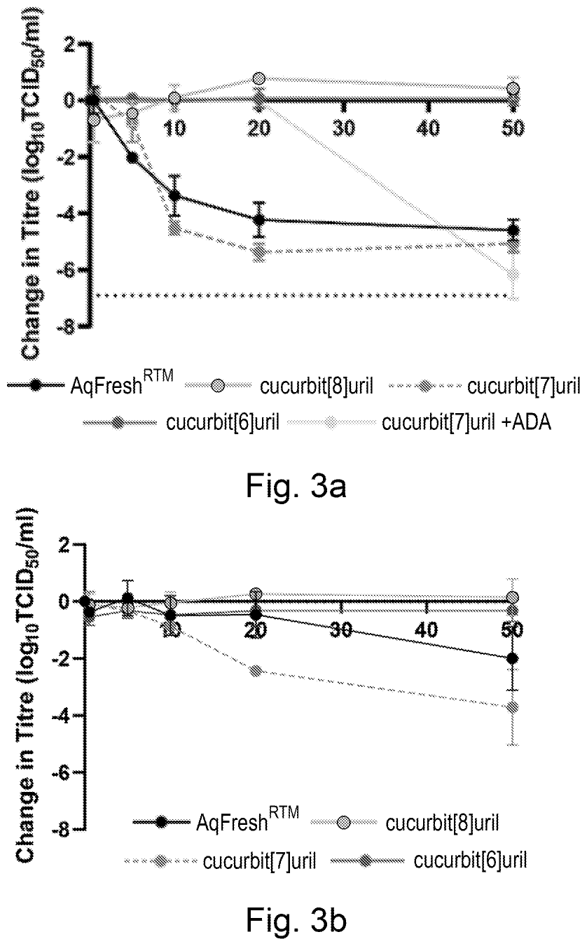

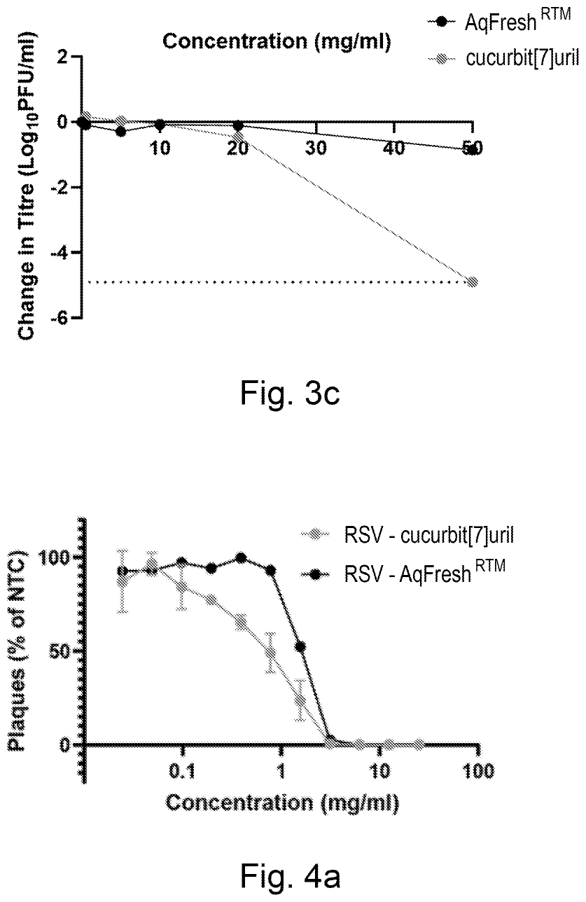

Each cucurbituril sample was mixed with the virus for 5 minutes before being serially diluted to determine viral titre. TCID₅₀ assays shown in FIG. 3a indicates that both AqFresh® and cucurbit[7]uril were effective at inhibiting herpes simplex virus serotype two (HSV-2), with an approximately 5 log reduction in viral titre observed at 20-50 mg/mL concentration. The lack of viral titre reduction observed in conjunction with cucurbit[6]uril and cucurbit[8]uril may indicate that it is the cucurbit[7]uril component of AqFresh® which is responsible for the reduction.

FIG. 3b shows the effects of AqFresh® and cucurbit[7]uril on respiratory syncytial virus (RSV). TCID₅₀ assays confirm that both were also antiviral against RSV, with a 2-3 log reduction in viral titre at the highest concentrations. As previously, cucurbit[6]uril and cucurbit[8]uril were ineffective.

FIG. 3c shows the effects of AqFresh® and cucurbit[7]uril on SARS-CoV-2, the human coronavirus responsible for the COVID-19 pandemic. Titration assays against SARS-CoV-2 demonstrate that AqFresh® and cucurbit[7]uril are both antiviral against SARS-CoV-2, but to different extents. AqFresh® only has limited efficacy, even at a 50 mg/mL concentration, whilst cucurbit[7]uril is highly effective at 50 mg/mL but largely ineffective at 20 mg/mL and below.

Guest-Host Chemistry Assay

Cucurbit[7]uril powder stock was mixed with adamantylamine in a 1:1 molar ratio and resuspended at 50 mg/mL in sterile dH₂O. Samples from this solution were then diluted further to form stocks of 50, 20, 10, 5 and 0.5 mg/mL.

In order to confirm that this inhibition was occurring on account of supramolecular binding of the cucurbituril to the virus (herpes simplex virus serotype two (HSV-2)), a guest-host chemistry assay with cucurbit[7]uril, where the cavity is occupied by 1-Adamantylamine (ADA) was carried out. ADA has one of the strongest binding affinities (1.7+/−0.8×10¹⁴ M⁻¹) with cucurbit[7]uril, meaning the cavity will be occupied. With the cavity occupied with ADA, no binding to the virus would be expected to occur. With reference to FIG. 3a, for the 0.5-20 mg/mL concentrations tested, this was confirmed and no antiviral effect was observed. However, we showed that at 50 mg/mL concentration, the 1:1 cucurbit[7]uril:ADA mixture was associated with a significant decrease in viral titre.

Dose-Response Assays

Cells were seeded at 170,000 per mL, with 500 μl of cell-and-media mixture added to each well of a 24 well plate (Corning, N.Y., USA). They were incubated at 37° C. overnight or until cells were 90-100% confluent. Sterile Eppendorf tubes were then prepared containing 570 μl of cucurbituril mixed with DMEM to provide the desired concentration of cucurbituril. A 1:100 dilution of virus stock was also prepared. 30 μl of this diluted virus stock was added to each Eppendorf containing 570 μl of cucurbituril/media mix. An additional Eppendorf tube was also prepared containing just 570 μl DMEM plus 30 μL diluted virus stock to act at the non-treatment control (NTC). Eppendorf tubes containing cucurbituril-virus mix and NTC Eppendorf were incubated for one hour at 37° C. and then all media was removed from the 24-well plate and 200 μL of each cucurbituril-virus mix added (in duplicate). The plate was then incubated for one hour at 37° C. Finally, the cucurbituril-virus mixes were removed by pipetting and 500 μL of methylcellulose DMEM was added to each well. The plate was then incubated under the formation of visible plaques. EC₅₀ (half maximal effective concentration) values were calculated by performing a non-linear fit of cucurbituril vs. response—variable slope (four parameters) in Graphpad Prism software, version 9.1.1.

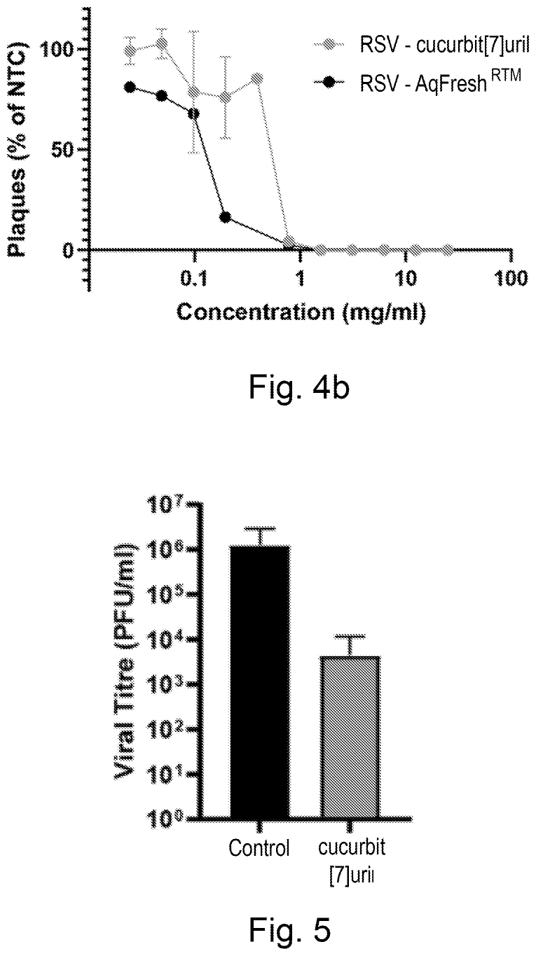

FIG. 4a shows that AqFresh® has an EC₅₀ of 1.51 mg/mL and cucurbit[7]uril has an EC₅₀ of 1.27 mg/mL for inhibiting herpes simplex virus serotype two (HSV-2).

FIG. 4b shows that cucurbit[7]uril has an EC₅₀ value of 1.07 mg/mL for respiratory syncytial virus (RSV).

Virucidal Assays

Cells appropriate to the virus were seeded into a 96-well plate at 15,000 cells per well and left until 90-100% confluent. Virus stock (55 μL) was incubated with the desired amount of cucurbituril to achieve the IC₉₀ concentration in 55 μL total volume (made up with PBS). A non-treatment control was also created, with 55 μL virus stock mixed with 55 μl PBS. Both virus plus cucurbituril and non-treatment controls were incubated for 1 hour at 37° C. Then six 2 mL Eppendorf tubes were prepared, each containing 450 μL of appropriate cell culture medium (three are used with cucurbituril, three with the non-treatment control). After incubation, 50 μL are taken from the virus plus cucurbituril mix and added into the first Eppendorf tube before being re-suspended 4-5 times. 50 μL is then serially diluted into the other two tubes, leaving three Eppendorf tubes at 1:20, 1:200 and 1:2000 dilution respectively. This process is also repeated for the non-treatment control. 50 μL from the virus plus antiviral mix (1:20 dilution) is then added to wells A1 and A2 of the 96-well plate. 50 μL from the 1:200 virus-antiviral mix is added to wells A3 and A4, and 50 μl from the 1:2000 virus-antiviral mix is added to wells A5 and A6. 50 μl from these wells is then serially diluted down the plate to row G. In well H1, 50 μL of the originally incubated virus plus cucurbituril is added, resuspended, and serially diluted to well H6. This process is repeated for the non-treatment control in wells A7-A12. The plate is then incubated for one hour at 37° C. All medium is then discarded and re-plated with 100 μL of methyl cellulose. The plate is then incubated at 37° C. until visible plaques are formed, before being stained with crystal violet to allow plaque-counting.

A virucidal assay is used to distinguish between destructive (virucidal) and non-destructive (virustatic) interactions between antivirals and viruses. In this instance, cucurbit[7]uril was mixed with inhibiting herpes simplex virus serotype two (HSV-2) for 60 minutes before being serially diluted across a 96-well plate. Were the interactions between the CBs and virus reversible non-destructive binding events, then serial dilution would cause removal of the CB from the viral surface and infections would be observed. However, with reference to FIG. 5, after serial dilution it was observed that there is a greater than 2-log reduction in viral titre indicating that the binding of cucurbit[7]uril to herpes simplex virus serotype two (HSV-2) is destructive and hence is virucidal.

DNA Exposure Assay

Treatment and DNase

100 μL of cell-free viral sample was mixed with 100 μL of cucurbituril (final concentration should preferable be between 50-400 μg/ml). A control where the viral sample is treated with pure media rather than cucurbituril was also be performed. This control was treated exactly in the same manner as the cucurbituril treated samples. This sample is known as the NTC. The samples were incubated for 1 hour at 37° C. in 5% CO₂ and 5 μl of each sample were removed and placed into new Eppendorf tubes. Then 5 μl of RNase free water was added to the Eppendorf tube and the tubes placed on ice. The DNA concentration of the samples was then measured using a NanoPhotometer® spectrophotometer. The samples (originally 5 μl aliquots of each sample) were then discarded.

10× Turbo™ DNase Buffer was then added to the main retained samples to 1× concentration in each sample. In the sample with the highest amount of DNA as measured by the nanophotometer, 1 μL of Turbo™ DNase per 1 μg DNA present was added. An equal volume of Turbo™ DNase was added to all the other samples. The samples were then incubated for 30 minutes at 37° C. in 5% CO₂. EDTA was then added to a final concentration of 15 mM and the samples heated at 75° C. for 10 minutes thereby deactivating the Turbo™ DNase.

Extraction

25 μL Proteinase K was then added to the samples (any samples of volume <200 μL are adjusted to a final volume of 200 μL using PBS). 200 μL lysis buffer was then added and the samples vortexed for 15 seconds. Then the samples were incubated at 56° C. for 15 minutes. Then 250 μL 96-100% molecular grade ethanol was added to the samples and vortexing continued for a further 15 seconds. The samples were then incubated for 5 minutes at room temperature and the samples added to a Viral Spin Column in a collection tube. The column was centrifuged at 6800×g for 1 minute and then collection tube was replaced. 500 μL wash buffer (WII) was then added the spin column centrifuged again at 6800×g for 1 minute (close lid). The collection tube was emptied and the wash buffer added again and the spin column centrifuged again. The collection tube was then replaced and the spin column centrifuged at maximum speed for 1 minute to remove any residual Wash Buffer (WII). The spin column was then placed in a clean Recovery Tube which was eluted with 50 μL sterile RNase-free water (water was added to the centre of the cartridge) and the sample incubated at room temperature for 1 minute. The spin column was centrifuged at maximum speed for 1 minute to elute nucleic acids. As the Recovery Tube contained the purified viral nucleic acids, the spin column was discarded. The purified viral DNA was stored at −80° C. if not immediately used for downstream applications.

PCR

The purified viral DNA samples were kept on ice and 5 μL of each sample removed and placed into new Eppendorf tubes. 5 ul of RNase free water was added to each Eppendorf tube and the tubes were placed on ice until the DNA concentration was measured using a NanoPhotometer® spectrophotometer. The samples (originally of 5 μL) were then discarded. The remaining main samples were prepared for and then run on a PCR machine.

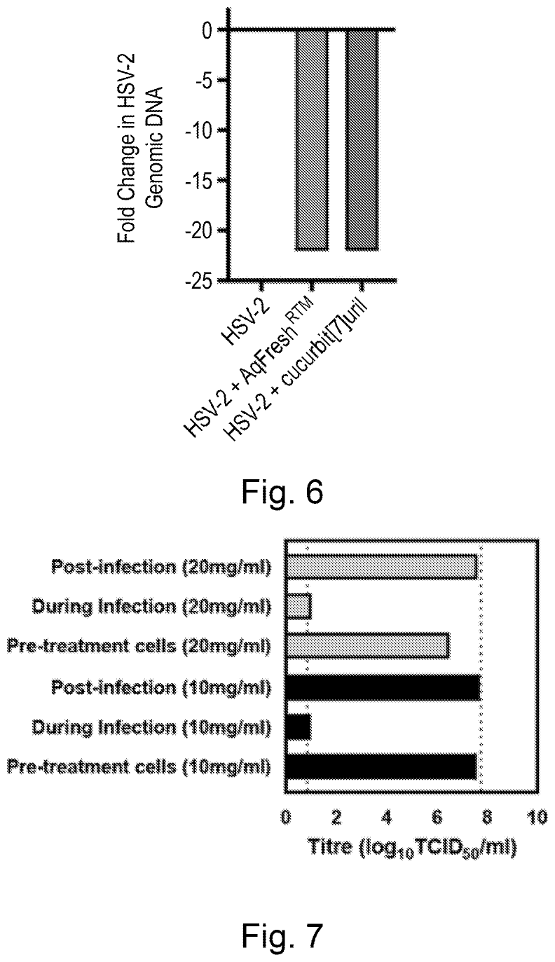

DNA exposure assays were performed to confirm the breakdown of the herpes simplex virus serotype two (HSV-2) viral capsid and release of the genome. FIG. 6 illustrates that no DNA is detected following viral exposure to cucurbit[7]uril or AqFresh®, subsequent exposure to DNAse, and PCR amplification. This absence suggests that the DNA was released following exposure to the cucurbituril, broken down by the enzyme, and could not be amplified. When the experiment was repeated with negative controls or cucurbit[6]uril in place of AqFresh® or cucurbit[7]uril, DNA was detected indicating that they did not break down the viral capsid. No DNA was detected following exposure to cucurbit[8]uril although this is due to an unexpected interaction between cucurbit[8]uril and assay constituents.

Time of Addition Study

Materials (10 or 20 mg) were added on cells 1 hour before infection, during infection or after infection, with viruses added using an multiplicity of infection (MOI) of 0.01, using a method described previously (Jones, S. T., et al. (‘Modified cyclodextrins as broad-spectrum antivirals’ Science Advances, 6, 5, eaax9318 (2020)) and Aoki-Utsubo et al., ‘Time-of-addition and temperature-shift assays to determine particular step(s) in the viral life cycle that is blocked by antiviral substance(s)’, Bio-Protocol, 8, 9, e2830 (2018)). Viral titres were then quantified by TCID₅₀ assay.

To further elucidate the antiviral mode of action of cucurbiturils, a series of time of addition studies was performed. FIG. 7 illustrates that an antiviral effect was observed when the cucurbit[7]uril was added directly to the virus (herpes simplex virus serotype two (HSV-2)) before infection (‘during infection’). We observed no viral inhibition when the cucurbit[7]uril was removed prior to viral introduction (pre-treatment’), or when added after the virus has already been exposed to the cells (‘post-infection’), further indicating that the cucurbit[7]uril binds directly to the virus.

1. A method of disinfecting or preventing infection of a gaseous environment by, a liquid of, or a solid surface of one of an enveloped virus, a non-enveloped virus, or a mixture thereof, the method comprising the step of treating the gaseous environment, liquid, or solid surface with a composition comprising an effective amount of one or more cucurbituril isomers, derivatives thereof, and variants thereof or, for preventing infection of a solid surface, comprising the step of producing the solid surface from a composition comprising an effective amount of one or more cucurbituril isomers, derivatives thereof, and variants thereof.

2. The method according to claim 1, wherein the enveloped virus is selected from the group consisting of family Herpesviridae, Poxviridae, Hepadnaviridae, Asfarviridae, Flaviviridae, Togaviridae, Coronaviridae, Orthomyxoviridae, Paramyxoviridae, Rhabdoviridae, Bunyavirales, Filoviridae, Pneumoviridae, and Retroviridae.

3. The method according to claim 1, wherein the enveloped virus is selected from the group consisting of genus simplexvirus, varicellovirus, orthopoxvirus, parapoxvirus, yatapoxvirus, molluscipoxvirus, orthohepadnavirus, hepacivirus, flavivirus, betacoronavirus, alphacoronavirus, deltacoronavirus, gammacoronavirus, alphainfluenzavirus, betainfluenzavirus, gammainfluenzavirus, morbillivirus, rubelavirus, lyssavirus, ebolavirus, orthopneumovirus, cytomegalovirus, and lentivirus.

4. The method according to claim 1, wherein the enveloped virus is selected from the group consisting of species herpes simplex virus 1, herpes simplex virus 2, varicella zoster virus, modified vaccinia virus Ankara (MVA), hepatitis B virus, hepatitis C virus, West Nile virus, dengue virus, tick-borne encephalitis virus, yellow fever virus, Zika virus, Middle East respiratory syndrome-related coronavirus, Severe acute respiratory syndrome-related coronavirus, influenza A virus, influenza B virus, influenza C virus, measles virus, mumps virus, rabies virus, ebola virus, respiratory syncytial virus, cytomegalovirus, HIV-1 virus and HIV-2 virus.

5. The method according to claim 1, wherein the non-enveloped virus is selected from the group consisting of family Picornaviridae, Caliciviridae, Adenoviridae, Reoviridae, Astroviridae, Circoviridae, Parvoviridae, Papillomaviridae and Polyomaviridae.

6. The method according to claim 1, wherein the non-enveloped virus is selected from the group consisting of genus enterovirus, rotavirus, norovirus, vesivirus, mastadenovirus, mamastrovirus, cyclovirus, protoparvovirus, alphapolyomavirus, betapolyomavirus, and gammapolyomavirus.

7. The method according to claim 1, wherein the non-enveloped virus is selected from the group consisting of species enterovirus A, enterovirus B, enterovirus C, coxsackievirus B4, poliovirus type 1, murine norovirus, feline calicivirus, rhinovirus A, rhinovirus B, rhinovirus C, Norwalk virus, Adenovirus type 5, and any one of rotavirus A to J.

8. The method according to claim 1, wherein the composition comprises a cucurbituril isomer selected from any one of cucurbit[6]uril, cucurbit[7]uril, cucurbit[8]uril, derivatives thereof, variants thereof, and mixtures thereof.

9. The method according to claim 8, wherein the composition comprises cucurbit[7]uril, derivatives thereof, variants thereof, and mixtures thereof.

10. The method according to claim 8, wherein the composition comprises cucurbit[8]uril, derivatives thereof, variants thereof, and mixtures thereof.

11. The method according to claim 10, wherein the composition additionally comprises cucurbit[6]uril, a derivative thereof, a variant thereof, or a mixture thereof, and cucurbit[7]uril, a derivative thereof, a variant thereof, or a mixture thereof.

12. The method according to claim 1, wherein the composition additionally comprises a virucide, optionally wherein the virucide is selected from the group consisting of phenoxyethanol, alcohols, chlorine based bleach, peroxide-based bleach, an aldehyde, a quaternary ammonium compound, a chlorhexidine, and an iodophor.

13. The method according to claim 12 wherein the composition comprises a cucurbituril isomer selected from any one of cucurbit[6]uril, cucurbit[7]uril, cucurbit[8]uril, derivatives thereof, variants thereof, and mixtures thereof, wherein the composition comprises cucurbit[8]uril, derivatives thereof, variants thereof, and mixtures thereof, wherein additionally the composition excludes other cucurbituril isomers, derivatives thereof, or variants thereof, and wherein the weight ratio between phenoxyethanol and cucurbit[8]uril, a derivative thereof, a variant thereof, or a mixture thereof is less than 9:1.

14. The method according to claim 12, wherein the composition comprises a cucurbituril isomer selected from any one of cucurbit[6]uril, cucurbit[7]uril, cucurbit[8]uril, derivatives thereof, variants thereof, and mixtures thereof, wherein the composition comprises cucurbit[8]uril, derivatives thereof, variants thereof, and mixtures thereof, wherein the composition additionally comprises cucurbit[6]uril, a derivative thereof, a variant thereof, or a mixture thereof, and cucurbit[7]uril, a derivative thereof, a variant thereof, or a mixture thereof, wherein additionally the weight ratio between phenoxyethanol and cucurbit[8]uril, a derivative thereof, a variant thereof, or a mixture thereof is more than 5:1.

15. The method according to claim 1, wherein the effective amount of one or more cucurbituril isomers, derivatives thereof, and variants thereof is in the range 0.000005-5, 0.00005-2, 0.0005-1, 0.005-1, 0.05-1% w/v.

16. The method according to claim 11, wherein cucurbit[8]uril, a derivative thereof, a variant thereof, or a mixture thereof comprises 10-30 w/w total cucurbiturils.

17. The method according to claim 11, wherein cucurbituril other than cucurbit[6]uril, cucurbit[7]uril, cucurbit[8]uril, derivatives thereof, variants thereof, or a mixture thereof comprises less than 5, less than 1, less than 0.5% w/w total cucurbiturils, optionally wherein cucurbituril other than cucurbit[6]uril, cucurbit[7]uril, cucurbit[8]uril, derivatives thereof, variants thereof, or a mixture thereof comprises at least 0.001 or at least 0.01% w/w total cucurbiturils, wherein cucurbituril other than cucurbit[6]uril, cucurbit[7]uril, cucurbit[8]uril, derivatives thereof, variants thereof, or a mixture thereof is selected from the group consisting of cucurbit[5]uril, any one of cucurbit[9]uril to cucurbit[20]uril, derivatives thereof, variants thereof and a mixture thereof.

18. The method according to claim 1, wherein the composition is in the form of a solution or liquid suspension, optionally suitable for dispensing as an aerosol or spray.

19. The method according to claim 1, wherein the composition is in the form of a liquid coating and the step of treating the solid surface is coating the solid surface with the liquid composition.

20. The method according to claim 1, wherein the solid surface is part of an air filter cartridge, part of an item of medical personal protective equipment, a wipe, or a human mucous membrane.
